(19) United States
(12) Patent Application Publication
(10) Pub. No.: US 2008/0186839 A1
(43) Pub. Date: Aug. 7, 2008

(54) Optical Information Carrier

(75) Inventors: Coen Theodorus Hubertus Fransiscus Liedenbaum, Eindhoven (NL); Johannes Leopoldus Bakx, Eindhoven (NL); Wil Ophey, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,962

(22) PCT Filed: Nov. 25, 2005
(86) PCT No.: PCT/IB2005/053907

§ 371 Date: Nov. 19, 2007

(30) Foreign Application Priority Data
Nov. 29, 2004 (EP) 04106140.9

(51) Int. Cl. G11B 7/242

(52) U.S. Cl. 369/284

(57) ABSTRACT

An optical information carrier comprises a data layer for carrying the information, an outer surface for receiving a light beam for reading the information, and a transparent layer for transmitting the light beam to the data layer. The transparent layer comprises a pattern of physical damages for locally deforming the light beam. The physical damages are embedded in the transparent layer at a depth between the outer surface and the data layer. In the pattern of physical damages additional information is encoded. The additional information may be used for the purpose of copy protection.

The invention relates to an optical information carrier comprising a data layer for comprising information, an outer surface for receiving a light beam for reading the information, and a transparent layer for transmitting the light beam to the data layer, the transparent layer comprising a pattern of deformations for deforming the light beam, the pattern comprising additional information.

The invention further relates to a method for manufacturing an optical information carrier.

The invention also relates to a device for reading information from an optical information carrier.

Many attempts have been made by the content industry relating to the distribution via optical media of music, software programs and video for protecting the content of optical storage media against unauthorized copying. Software solutions as well as hardware solution have been used for this purpose. Most solutions restrict the amount of unauthorized copying, but can easily be circumvented by hackers.

One of the previously described hardware solutions is the intentional introduction of physical damage to a portion of an optical disc as disclosed in the U.S. Pat. No. 5,572,589. Said patent discloses an optical disc and physically damaging tracks or sectors. A laser is used for selectively damaging the tracks or a sharp instrument is used for scratching the disc surface. The damaged portions form a pattern which represents an identifying value for the disc. At the disc surface the diameter of the light beam is relatively large. As the light beam travels through the transparent layer the beam gets smaller. Small scratches at the disc only deform a relatively small part of the light beam and are difficult to detect. In order to apply physical damages which can be detected by the reading device, the physical damages thus have to be relatively large. It is a disadvantage of the optical disc according to U.S. Pat. No. 5,572,589 that due to the relatively large physical damages, the data density of the additional information is relatively low. Moreover, hackers may create copies of the information carrier comprising the physical damages of the outer surface using a sharp instrument.

It is an object of the invention to provide an optical information carrier with a pattern of deformations, the pattern comprising additional data with a high data density.

According to the invention an optical information carrier as described in the opening paragraph is provided, wherein the deformations are embedded in the transparent layer, at a depth between the outer surface and the data layer.

The deformations are, for example, bubbles or cavities which may cause, index modulations or birefringence. As the deformations are embedded in the substrate, they are closer to the data layer than the physical damages of the disc surface and do not damage the data tracks itself as disclosed in the prior art. Therefore relatively small deformations can be used, enabling a reliable pattern with a higher density of the additional data.

It is an advantage of the information carrier according to the invention that the deformation are more difficult to change or copy than the physical damages in the prior art discs. It is relatively easy to append damages to an outer surface of an information carrier, especially when the damages are relatively large and can be applied mechanically. For applying smaller deformations to the internal structure of the transparent layer, special equipment is required.

In an advantageous embodiment of the optical information carrier according to the invention, at least part of the information is locked and the pattern constitutes a key for unlocking at least part of the locked information. The locked information may, for example, be protected with a password or encrypted using an encryption technique, such as PGP. The key may thus be a password for enabling (or allowing) a reading device to start extracting the information from the data layer or may be necessary for decrypting encrypted information. Even if a hacker may, despite of the deformations, succeed in copying the information onto a data layer of another information carrier he would not be able to copy the key and the duplicate will be useless.

The information on the data layer may comprise a software application which, when run, queries the key. When the software application instructs the reading device to read the key and no correct key is found, (part of) the data is not accessible.

In an embodiment of the optical information carrier according to the invention, the pattern comprises deformations embedded in the transparent layer between the outer surface and the data layer at at least two different depths. When the deformations are embedded in the transparent layer at different depths it will be even more difficult to duplicate the information carrier including the deformations. Different layers may be used for comprising different keys. For example, two different keys are required for unlocking locked information or different keys are required for unlocking different parts of the information on the data layer.

The deformations may be realized as different types of deformations, each type of deformations locally deforming the light beam differently. For example, some deformations may be such that a light detecting unit of a reading device detects changes in a total reflection of the light beam at the disc surface. Alternatively a deformation of a specific type may result in minor changes to an automatic gain control, focus error or tracking error signal, which changes can be detected by a reading device.

The invention also relates to a device for reading information from an optical information carrier according to the invention, comprising a light detecting unit for obtaining the information from the light beam, the light detecting unit being arranged for analyzing a light intensity distribution on the light detecting unit for detection of the embedded deformations. The deformations in the transparent layer locally deform the light beam for reading the information. The deformations in the transparent layer are such that their presence can be deduced from an intensity pattern of the light beam. The light detecting unit may, for example, detect a pattern of normal data blocks representing the information on the data layer and faulty blocks, representing the deformations in the transparent layer. From this pattern a key may be inferred for unlocking part of the data.

When a software application asks for the key, the application instructs the reading device to read data from that part of the information carrier where the key is expected. From the intensity pattern of the light beam, measured by the light detecting unit, it can be inferred whether the key is present in the information carrier. The software application may, for example, look for specific faulty data blocks. If the device is arranged for providing the relevant signals and the relevant signals are encoded in the deformations, also focus error signals, tracking error signals or automatic gain control signals may comprise the key.

The invention also relates to a method for manufacturing an optical information carrier according to the invention, comprising a step of embedding the pattern of deformations in the transparent layer of the information carrier, at a depth between the outer surface and the data layer.

The step of embedding the pattern of deformations may, for example, comprise exposing the transparent layer via a mask to radiation from a radiation source for creating the deformations embedded in the transparent layer.

In a preferred embodiment of the method according to the invention the mask comprises an array of micro lenses and the radiation source is a light source, the micro lenses being arranged for focussing the light source at specific depths in the transparent layer for creating the deformations in the transparent layer. The light beam may be provided by, for example, a Nd-Yag laser unit. The focussed Nd-Yag laser causes deformations in the substrate. The deformations may be in the form of, for example, bubbles or cavities.

These and other aspects of the invention are apparent from and will be elucidated with reference to the embodiments described hereinafter.

### BRIEF DESCRIPTION OF THE DRAWINGS

In the drawings:

FIG. 1 schematically shows an embodiment of an information carrier according to the invention,

FIG. 2 schematically shows an embodiment of an information carrier according to the invention comprising deformations at different depths,

FIG. 3 schematically shows an embodiment of an information carrier according to the invention comprising two data layers,

FIG. 4 schematically shows an embodiment of an information carrier according to the invention comprising deformations at different depths and two data layers,

FIG. 5 schematically shows an embodiment of a reading device according to the invention,

FIG. 6 shows a flow diagram of a method according tot the invention, and

FIGS. 7a and 7b schematically show a mask for use in a process of manufacturing an information carrier according to the invention.

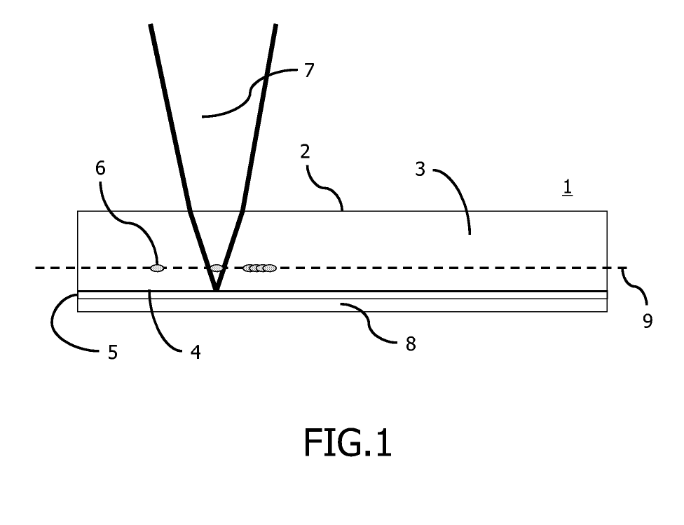

FIG. 1 schematically shows an embodiment of an information carrier 1 according to the invention. The information carrier 1 may have any possible geometric shape. The information carrier 1 may, for example, be disc shaped like a CD or DVD or rectangular like a credit card. A light beam 7 for reading the information enters a transparent layer 3 of the information carrier 1 at an outer surface 2 of the information carrier 1. The transparent layer 3 transmits the light beam 7 to the data layer 4. The information is comprised in the data layer 4 and may, for example, be stored in a pattern of pits as in CDs, DVDs or Bluray discs or in a pattern of dark and light areas as in CD-R or CD-RW. In CDs and DVDs, the transparent layer generally is a polycarbonate substrate layer. In Bluray discs the transparent layer generally is the cover of a protective cartridge. The light beam is reflected at the reflective layer 5. The reflected beam is used by a reading device for detecting the information. The information carrier 1 may further comprise a cover layer 8 for protecting the reflective layer 5 and/or comprising a visual label.

Deformations 6 are embedded in the transparent layer 3 and are realized by deforming the material of the transparent layer (3). In the information carrier 1 shown in FIG. 1 the deformations are arranged in a plane 9, parallel to and between the data layer 4 and the outer surface 2 of the record carrier. When the light beam 7 travels through the transparent layer 3 to the data layer 4, the deformations locally deform the light beam 7. A reading device is arranged for obtaining the information from the reflected beam and for detecting the deformations of the light beam 7 which correspond to deformations 6 in the transparent layer 3. Additional data is encoded in the deformations 6 of the transparent layer 3 and is detected by the reading device. The additional data may, for example, be used for copy protection, unique disc identifying codes or information about the manufacturing process.

The additional data may comprise a key which is required for unlocking locked information. Part of the information, stored on the data layer 4 may be locked. The locked information may, for example, be protected with a password or encrypted using an encryption technique, such as PGP. The key may thus be a password for enabling (or allowing) a reading device to start extracting the information from the data layer 4 or may be necessary for decrypting encrypted information. When the key is required for obtaining (part of) the information, a copy of the information carrier 1 has to comprise the deformations 6 in the transparent layer. Even if a hacker may, despite of the deformations, succeed in copying the information onto a data layer of another information carrier he would not be able to copy the key and the duplicate will be useless.

In an embodiment of the information carrier 1 according to the invention, the information carrier 1 is a CD comprising music. The deformations 6 are such that the light beam 7 is only deformed so much that the error correction methods performed by general CD players can easily correct for these deformations. Preferably the deformations are also such that general writing devices for writing data onto recordable discs can not correct for these deformations. The deformations may cause a copy process to be interrupted because of writing errors or may cause the data which is written on the disc to comprise uncorrectable errors. A software application may also be stored on the disc, which runs whenever the disc is used with a computer. The application queries the disc at specific locations for detecting the pattern of deformations 6. If the application decides that a key which is encoded in the pattern of deformations 6 is valid, the application plays the music.

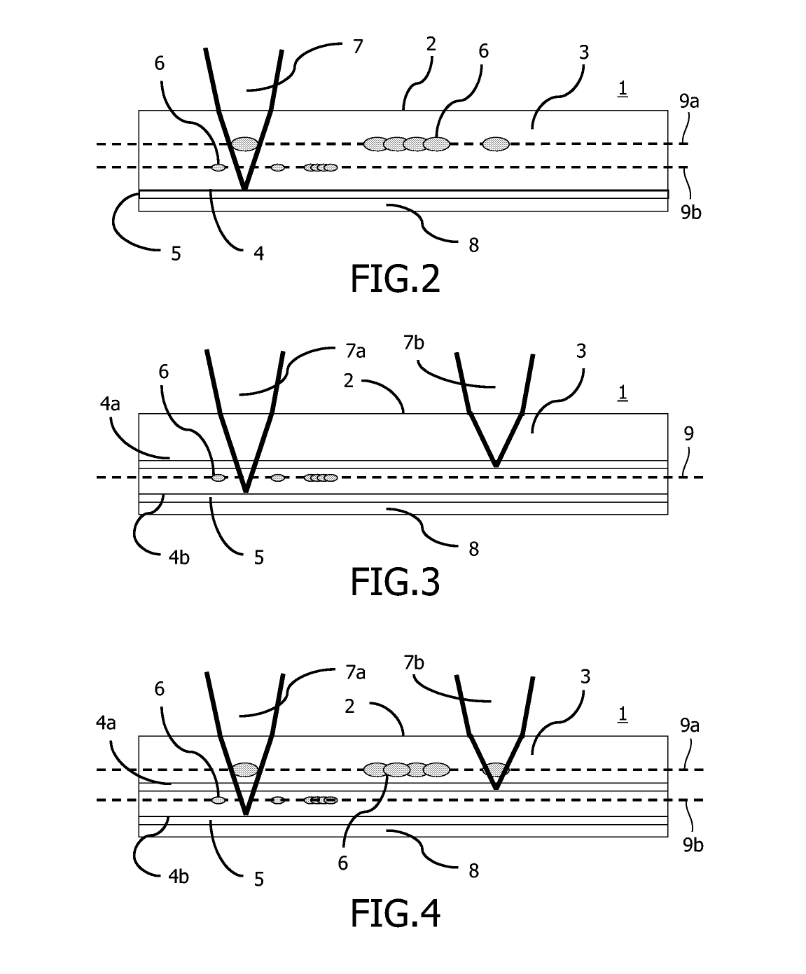

FIG. 2 schematically shows an embodiment of an information carrier 1 according to the invention comprising deformations 6 at different depths. In this embodiment the deformations 6 are embedded in the transparent layer 3 and arranged in two separate planes 9a and 9b. The different depths at which the deformations 6 are embedded make it even more difficult to copy the information carrier with the deformations 6. The deformations 6 in the plane 9b close to the data layer 4 are smaller than the deformations 6 in the other plane 9a. Also the convergent light beam 7 is smaller close the data layer 4 than close to the outer surface. Therefore the deformations 6 in both planes 9a and 9b have the same deforming effect on the light beam 7 and a reading device does not differentiate between deformations embedded at the different depths. Alternatively the deformations 6 in both planes 9a and 9b may have different deforming effects on the light beam 7. The difference may enable a reading device to differentiate between deformations embedded at the different depths.

FIG. 3 schematically shows an embodiment of an information carrier 1 according to the invention comprising two data layers 4a, 4b. In the embodiment shown in FIG. 3 deformations 6 are only applied to the transparent layer 3 between both data layers 4a, 4b. In such an information carrier 1 it is possible to protect the information on the second data layer 4b from copying, while the information on the first data layer 4a is not protected.

FIG. 4 schematically shows an embodiment of an information carrier according to the invention comprising deformations at different depths and two data layers. In the embodiment shown in FIG. 4 deformations 6 are applied to the transparent layer 3 just above both data layers 4a, 4b and the data on both data layers 4a, 4b may be copy protected.

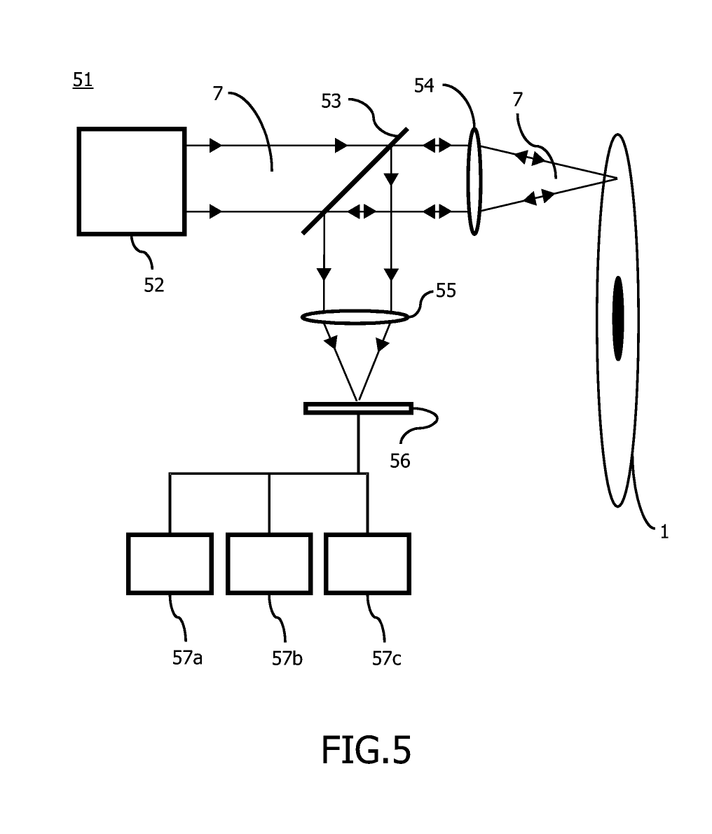

FIG. 5 schematically shows an embodiment of a reading device 51 according to the invention. The reading device 51 comprises a light beam producing unit 52, which creates the light beam 7 for reading the information. In most devices for reading information from an optical information carrier 1 the light beam 7 will be a laser beam. An objective lens 54 focuses the light beam 7 to form a light spot on the data layer 4 of the optical information carrier 1. The light beam 7 is then reflected at the reflective layer 5 of the information carrier 1 and. The reflected beam passes the objective lens 54 again and the semi-reflective mirror 53 directs the light beam to a second lens 55 which focuses the light beam on a light detector 56. The intensity of the light spot detected by the light detector 56 depends on the information which is stored on the data layer 4 at the position where the focused light spot hits the data layer 4. From the intensity pattern on the light detector 56 the information on the data layer 4 of the information carrier is obtained. Deformations 6 in the transparent layer 3 of the information carrier 1 influence the intensity pattern of the light spot on the light detector 56. For example, the deformations 6 may result in faulty data blocks or fluctuations in the total intensity of the light spot on the detector 56.

The reading device 51 shown in FIG. 5 further comprises an automatic gain control unit 57a, a focus error detection unit 57b and a tracking error detection unit 57c. In regular reading devices these units are used for detection and/or correction of all sorts of errors relating to the reading of information from the data layer. Specific deformations 6 in the transparent layer 3 may result in minor changes to an automatic gain control, focus error or tracking error signal. The deformations 6 may, for example, result in adding a high frequency signal to the focus error signal, which high frequency signal does not negatively influence the focus error correction capabilities of the device. The signal changes can be detected by the detection units 57a, 57b, 57c using, for example, a high pass filter or signal pattern detection of specific signal elements.

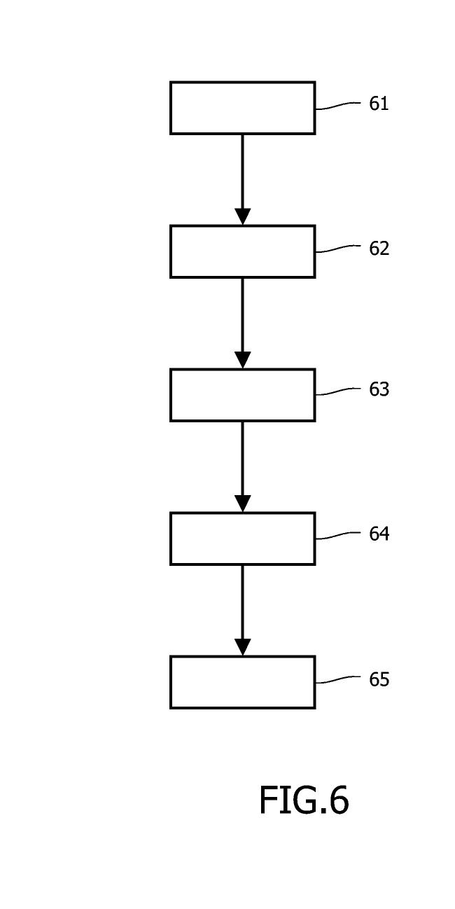

FIG. 6 shows a flow diagram of a method according to the invention. The method shown in FIG. 6 results in an optical information carrier according to the invention, wherein the additional information is required for unlocking locked information on the data layer. The method comprises the following steps:

A data read step 61 for acquiring the information to be recorded on the data layer of the information carrier.

A key generating step 62 for creating a key which will be required for reading the data from the information carrier.

A data lock step 63 for locking the information in dependence of the generated key.

A data write step 64 for applying the locked information to the data layer of the information carrier. This step may include the use of a laser device for writing information on the data layer, or creating and/or using a glass master for pressing the information onto the data layer. Such steps are well known in the art of optical recording.

An apply key step 65 for applying the key, generated in the key generating step 62, to the transparent layer of information carrier. The key is represented by a pattern of deformations in the transparent layer of the information carrier, somewhere between the outer surface and the data layer. The apply key step 65 includes the calculation of the pattern of deformations, based on the key generated in step 62 and the embedding of the deformations in the transparent layer. The embedding of the deformations may, for example, be realized by exposing a mask to radiation from a radiation source. The radiation source preferably is a powerful light source, such as a Nd-Yag laser module. The mask may comprise an array of micro lenses for focussing the light at specific depths in the transparent layer for creating the desired pattern of deformations in the transparent layer. Alternatively the key may be applied using a writing process which comprises a step of focussing a Nd-Yag laser or other radiation source at specific locations in the transparent layer using mechanical translation of the radiation source and/or the information carrier.

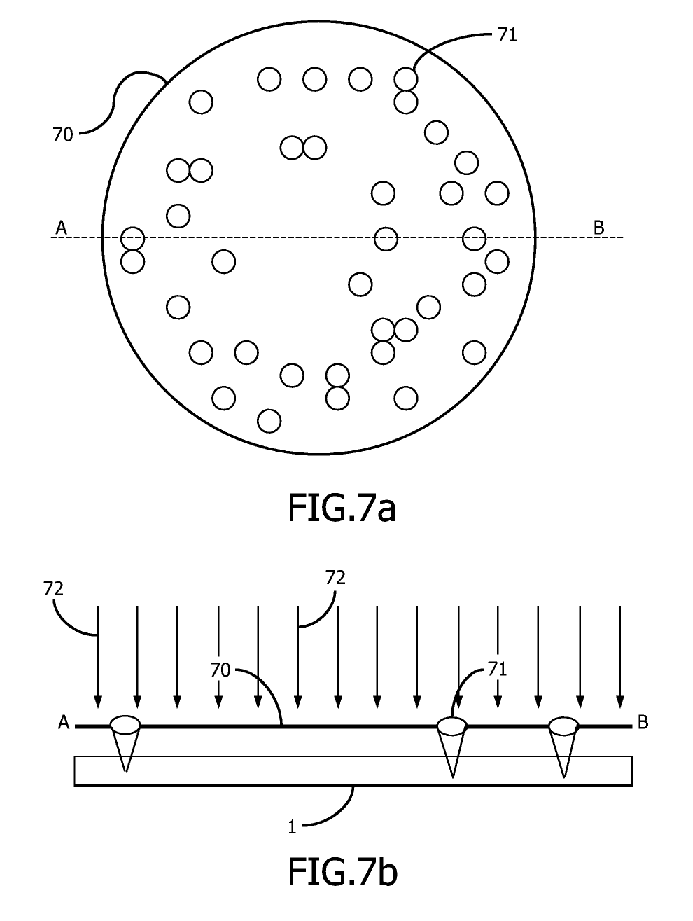

FIGS. 7a and 7b schematically show a mask 70 for use in a process of manufacturing an information carrier 1 according to the invention. FIG. 7a is a top view of the mask 70, FIG. 7b is a side view. The mask 70 comprises an array of micro lenses for focussing the light. In the side view, which shows a cross section of the mask through the line A-B in FIG. 7a, also the light 72 from the light source is shown. The micro lenses 71 focus the light at specific depths in the transparent layer for creating the desired pattern of deformations in the transparent layer of the optical information carrier 1.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An optical information carrier (1) comprising:
a data layer (4) for comprising information,
an outer surface (2) for receiving a light beam (7) for reading the information, and
a transparent layer (3) for transmitting the light beam (7) to the data layer (4), the transparent layer (3) comprising a pattern of deformations (6) of the transparent layer (3) for locally deforming the light beam (7), the pattern comprising additional information, the deformations (6) being embedded in the transparent layer (3) at a depth between the outer surface (2) and the data layer (4).

2. An optical information carrier as claimed in claim 1, wherein at least part of the information is locked and the pattern constitutes a key for unlocking at least part of the locked information.

3. An optical information carrier as claimed in claim 2, wherein the information comprises a software application which, when run, queries the key.

4. An optical information carrier as claimed in claim 1, wherein the pattern comprises deformations embedded in the transparent layer between the outer surface and the data layer at at least two different depths.

5. An optical information carrier as claimed in claim 4, comprising multiple data layers and multiple transparent layers, the deformations being embedded in at least one of the transparent layers between the outer surface and at least one of the data layers.

6. An optical information carrier as claimed in claim 1, wherein the deformations are realized as different types of deformations, each type of deformations locally deforming the light beam differently.

7. A device for reading information from an optical information carrier as claimed in claim 1, the device comprising a light detecting unit for obtaining the information from the light beam, the light detecting unit being arranged for analyzing a light intensity distribution on the light detecting unit for detection of the embedded deformations.

8. A device as claimed in claim 7, further comprising an automatic gain control unit and/or a focus error detection unit and/or a tracking error detection unit, at least one of said units being arranged for the detection of the embedded deformations.

9. A method for manufacturing an optical information carrier as claimed in claim 1, comprising a step of embedding the pattern of deformations in the transparent layer of the information carrier, at a depth between the outer surface and the data layer.

10. A method as claimed in claim 9, wherein the step of embedding the pattern of deformations comprises exposing the transparent layer via a mask to radiation from a radiation source for creating the deformations embedded in the transparent layer.

11. A method as claimed in claim 10, wherein the mask comprises an array of micro lenses and the radiation source is a light source, the micro lenses being arranged for focussing the light source at specific depths in the transparent layer for creating the deformations in the transparent layer.
